(19) United States
(12) Patent Application Publication
(10) Pub. No.: US 2006/0170849 A1
(43) Pub. Date: Aug. 3, 2006

(54) Transflective LCD panel

(76) Inventor: Li-Sen Chuang, Penghu (TW)

Correspondence Address: RABIN & BERDO, P.C.;Suite 500, 1101 14 Street, N.W., Washington, DC, 20005, US

(21) Appl. No.: 11/043,923

(22) Filed: Jan. 28, 2005

(51) Int. Cl. G02F 1/1335

(52) U.S. Cl. 349/117; 349/114

(57) ABSTRACT

A transflective LCD panel is disclosed. It uses a backlight structure of a transmissive LCD panel. Polarizers with compensation films are added to the top and bottom of the LCD panel. Through appropriate rotations of the liquid crystal materials and the angle between the compensation film polarization direction and the polarizer, the display panel of the transmissive LCD can also achieve reflection effects.

### BACKGROUND OF THE INVENTION

1. Field of Invention

The invention relates to a LCD panel and, in particular, to a transflective LCD panel.

2. Related Art

The liquid crystal display (LCD) technology includes both the reflective type and the transmissive type. The former does not need a backlight source. It uses a reflective plate attached into the LCD panel to reflect external light. One of its advantages is energy conservative (only a fraction of power needed for the transmissive LCD). Its major drawback is that it is hard to view the screen in a darker environment and its contrast is worse. Therefore, it usually uses a front light source as its auxiliary source. However, when the environmental light is not sufficient, the purely reflective LCD has inferior contrast and brightness. On the other hand, the transmissive LCD has a weaker contrast when the environmental light is too strong. Therefore, it would be ideal to make the transflective type of LCD panels by combining both technologies. Such LCD panels have the advantages of both types, using external light when it is strong and turning on the backlight when the environment is dark.

For portable electronic device displays, such as those on mobile phones and PDA's, the primary concern is low voltage and power consumption. Therefore, for those that are not featuring animations, TN/STN displays are the best choices. However, when implementing the transflective type of structures on conventional TN displays, the thickness of the liquid crystal layer is fixed while the light paths of transmissive and reflective light are different. Therefore, the reflective images have an inferior quality. It is thus difficult to have both transmissive and reflective display on a conventional TN display.

To increase the quality of reflective images, one has to insert a dual gap structure. That is, one builds a reflective structure inside the liquid crystal layer to control the light paths of the transmissive and reflective light. However, this method complicates the manufacturing process and the product structure. Moreover, normal transflective LCD often has some brightness attenuation when light travels through the reflective structure, resulting in limited applications.

### SUMMARY OF THE INVENTION

In view of the foregoing problems in the prior art, the invention provides a transflective LCD panel which, along with a backlight structure of the transmissive LCD panel and polarizers with compensation films added to the top and bottom of the LCD panel structure, generates both transmissive and reflective effects.

The backlight module is the primary element of the transmissive LCD panel to provide the LCD panel a homogeneous light source with high brightness and wide viewing angle. The basic principle is to convert a commonly used point or line light source into a highly bright and homogeneous plane light source through an effective mechanism. The normal backlight structure uses linear cold cathode fluorescent tube. The light enters a light guide plate or via a reflector to reflect it into light guide plate. The function of the light guide plate is to control the direction of the light beam to increase and homogenize its brightness. One can use an organic light guide plate with high transmissivity and make reflective dots on the plate surface. Through the reflective dot design, light beams undergo several times of total reflections and deflections, thereby homogeneously distributing light on the plate to form a plane light source.

The disclosed transflective LCD panel combines the backlight structure and two pieces of polarizers with compensation films to produce image reflection effects. Its structure includes a first transparent substrate, a second transparent substrate, a liquid crystal material, a first polarizer, a second polarizer, a backlight structure, and a gap between the first and second transparent substrates. The TN liquid crystal material is filled in the gap. The first and second transparent substrates are imposed a voltage on the TN liquid crystal material through several electrodes formed on their surfaces. The first transparent substrate has a first polarizer. The second transparent substrate has a second polarizer. These two polarizers have a compensation film with a delay of one-quarter wavelength. The backlight structure is formed on the surface of the first transparent substrate that is in contact with the exterior for providing an incident beam. The incident beam penetrates through the first transparent substrate and emits via the second transparent substrate, forming penetrating images. At the same time, the external incident light can enter through the second transparent substrate. Using the backlight structure design and two polarizers with compensation films, image reflection effects can be achieved on the second transparent substrate.

The twisting angle of the TN liquid crystal material is between 0 and 50 degrees. The transimission axis of the first and second polarizers are perpendicular to each other. The angle between the slow axis of the compensation film and the transmission axis of the polarizer is 45 degrees. To enhance the contrast and image quality of the transmissive display panel, one can also form an anti-reflective (AR) layer on the display panel.

### BRIEF DESCRIPTION OF THE DRAWINGS

The invention will become more fully understood from the detailed figures given hereinbelow, and thus are not limitative of the present invention, and wherein:

FIG. 1 is a schematic view of the disclosed transflective LCD panel;

FIG. 2 is a schematic view of the disclosed reflective display mode; and

FIG. 3 is a schematic view of the disclosed transmissive display mode.

### DETAILED DESCRIPTION OF THE INVENTION

The invention discloses a transflective liquid crystal display (LCD) panel. It combines a backlight structure and polarizers with compensation films to achieve the transmissive and reflective displays on a transmission type panel.

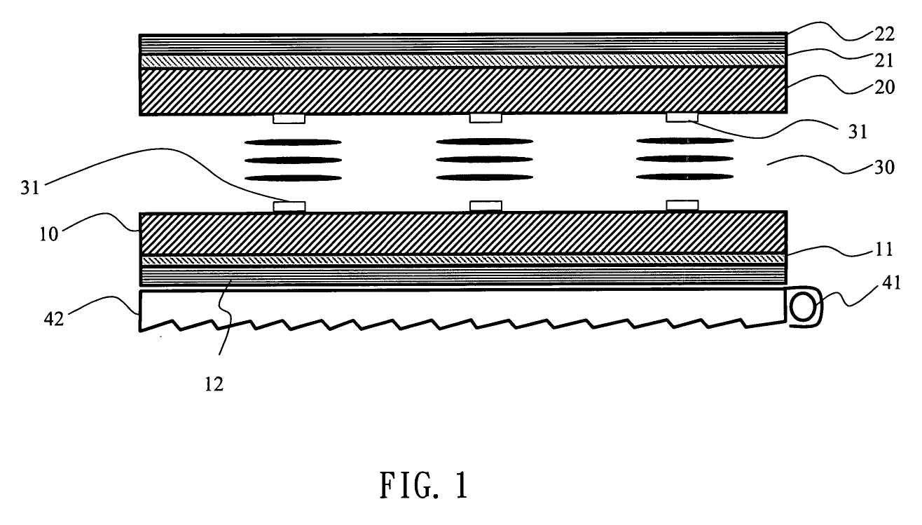

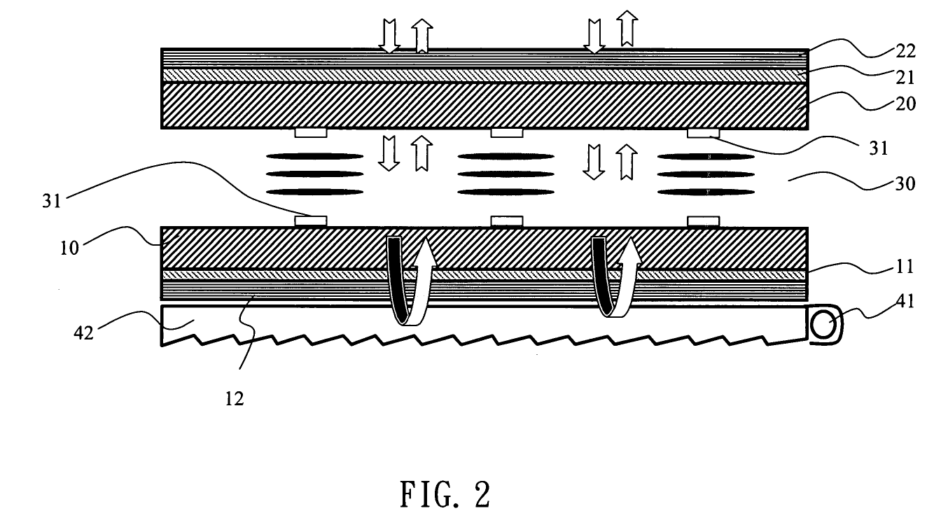

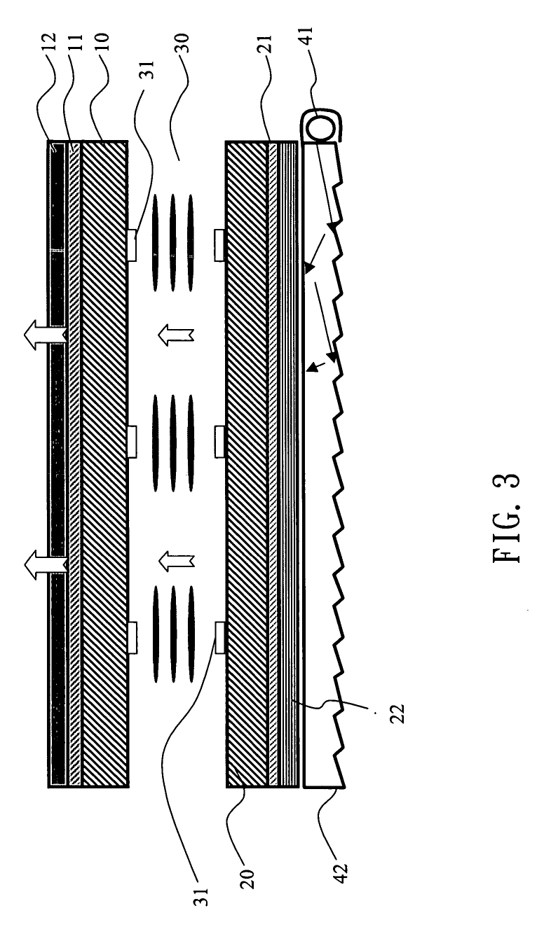

Please refer to FIG. 1 for a schematic view of the disclosed transmissive and reflective types of LCD panels. In the embodiment, it contains a transmissive display panel and a backlight structure. As shown in the drawing, the transmissive display panel includes a first transparent substrate 10, a second transparent substrate 20, and a plurality of electrodes 31, a TN liquid crystal material 30, a first polarizer 12 and a second polarizer 22 that contains compensation films 11, 21, respectively. There is a gap between the first transparent substrate 10 and the second transparent substrate 20. The TN liquid crystal material 30 fills the gap. The first polarizer 12 is on the surface of the first transparent substrate 10; the second polarizer 22 is on the second transparent substrate 20. The two polarizers 12, 22 have compensation films 11, 21 with a delay of one-quarter wavelength, respectively. The twisting angle of the TN liquid crystal material 30 is between 0 and 50 degrees. The transmission axis of the first and second polarizers 12, 22 are perpendicular to each other. The slow axis of the compensation films 11, 21 sustain an angle of 45 degrees difference from that transmission axis of the polarizers 12, 22, respectively. The backlight structure is formed with a light source 41 and a light guide plate 42. The light guide plate 42 is installed on one side of the first transparent substrate 10. The light source 41 provides a beam of light to the light guide plate 42 so that the light guide plate 42 can provide a homogeneous beam of light. The incident beam penetrates through the first transparent substrate 10 and exits from the second transparent substrate 20, forming transmissive images. The reflective display mode of the embodiment is shown in FIG. 2. When the external incident light is provided by the environment of some illuminating device, the incident light passes through the second polarizers 22, the compensation films 21, the second transparent substrate 20,the first transparent substrate 10, the compensation film 11, the first polarizer 12 and reflected from light guide plate 42. The transmissive display mode is shown in FIG. 3. The light source 41 of the backlight structure and the light guide plate 42 are used as the backlight source of the display panel. As shown in the drawing, after passing through the first transparent substrate 10 and the TN liquid crystal material 30 the incident beam emits from the second transparent substrate 20 to form a transmissive image.

To increase the contrast and quality of transmissive images, one can form an anti-reflection (AR) coating on the side of the display panel, reducing extra light reflected by metal signal lines in the LCD panel. The AR coating can be formed on the surface of the second transparent substrate using a specially processed black matrix. The black matrix can be made from black resin or Cr/CrO_{X}.

The disclosed transflective LCD panel can produce transmissive and reflective images without needing any reflector or dual gap structure. As it does not require any reflector, no attenuation occurs to the transmissive light and the light usage efficiency in the transmissive mode is enhanced.

Certain variations would be apparent to those skilled in the art, which variations are considered within the spirit and scope of the claimed invention.

What is claimed is:

1. A transflective liquid crystal display (LCD) panel comprising:
a first transparent substrate, which comprises a first polarizer with a first compensation film, wherein the first compensation film has one-quarter wavelength delay;
a second transparent substrate, which comprises a second polarizer with a second compensation film, wherein the second compensation film has one-quarter wavelength;
a liquid crystal material, which fills between the first and the second transparent substrate; and
a backlight structure, which is designed to reflect external incident light.

2. The transflective LCD panel of claim 1, wherein the backlight structure is comprised of a light source and a light guide plate, the light guide plate being installed on one side of the first transparent substrate.

3. The transflective LCD panel of claim 1, wherein the liquid crystal material has a twisting angle between 0 and 50 degrees.

4. The transflective LCD panel of claim 1, wherein the transmission axis of the first polarizer and the second polarizer are perpendicular to each other.

5. The transflective LCD panel of claim 1, wherein the angle between the slow axis of the compensation film and transmission axis of the corresponding polarizer is 45 degrees.

6. The transflective LCD panel of claim 1, wherein the second transparent substrate contains an anti-reflection (AR) coating.

7. The transflective LCD panel of claim 1, wherein the AR coating is a black matrix.

8. The transflective LCD panel of claim 7, wherein the black matrix is black resin or Cr/CrO_{X}.

9. The transflective LCD panel of claim 7, wherein the black matrix is formed on the surface of the second transparent substrate.
